(19) United States
(12) Patent Application Publication
(10) Pub. No.: US 2015/0227970 A1
(43) Pub. Date: Aug. 13, 2015

(54) SYSTEM AND METHOD FOR PROVIDING MOVIE FILE EMBEDDED WITH ADVERTISEMENT MOVIE

(71) Applicant: HowsCreative, Seoul (KR)

(72) Inventor: Sung Yong Lee, Seoul (KR)

(73) Assignee: HowsCreative, Seoul (KR)

(21) Appl. No.: 14/234,372

(22) PCT Filed: Nov. 1, 2013
(86) PCT No.: PCT/KR2013/009862

§ 371 Date: Jan. 22, 2014

(30) Foreign Application Priority Data
May 3, 2012 (KR) 10-2013-0049814
Sep. 17, 2013 (KR) 10-2013-0111732

(51) Int. Cl. G06Q 30/02

(52) U.S. Cl. CPC G06Q 30/0254

(57) ABSTRACT

Systems and methods for producing an advertisement movie that can produce an advertisement where the correlation between a movie data and an object which is the target of the advertisement is increased using big data solution, in producing advertisements for movies, and systems and methods for playing the advertisement movie produced thereby with movie data are disclosed.

### RELATED APPLICATION DATA

This application is a US National Phase of International Application No. PCT/KR2013/009862, filed on Nov. 1, 2013, which claims the benefit of Korean Application No. KR 10-2013-0049814, filed on May 3, 2013, and Korean Application No. KR 10-2013-0111732, filed on Sep. 17, 2013. This application hereby incorporates by reference the international and foreign priority applications enumerated herein.

### TECHNICAL FIELD

The present invention relates to systems and methods for producing an advertisement movie, and the production of a movie file for embedding the produced advertisement movie in the movie file. To be specific, the present invention relates to a method for producing an advertisement movie that can produce an advertisement where the correlation between an object which is the target of the advertisement and movie data is increased, in producing advertisements for movies, a producing system using the method, and a method for playing the movie data produced thereby.

### BACKGROUND

Recently, as technologies of computers, communications and semiconductors develop, with regard to a system for playing a multimedia material, for example, in a system for playing a movie, an image system is changed from an analog film system to a digital file projection system, shows various advantages in view of audience, producers/distributors and theaters which results in raising efficiency and reducing costs in the overall movie industry, compared with previous systems. Also, the number of audience increases every year.

Accordingly, advertisers are using advertisements in various forms in order to offer and promote the availability, characteristics and convenience of goods and services to unspecific individuals to induce consumers' demands or purchases, or to improve their own image and reliability.

However, in the twenty-first century, an era of rapid change where everything around us such as information, technology, media, etc., rapidly changes, the marketing and the advertisement, which is a tool for the marketing, also change. That is, as the media changes, the advertisement changes and the consumer behavior also changes accordingly. These changes become cause and effect of one another, and continue the overall change. From the viewpoint of the marketing communications, the most significant changes would be structural changes in existing media markets.

In particular, in the case of general advertisements on public TV, there is a temporal limitation on the show time due to advertisement costs. Further, when advertisements are shown, viewers strongly tend to avoid the advertisements by zipping and zapping using TV remote controls. Also, as viewers are exposed to various media, the preferred media are fragmented and their preferences also become clearer. According to these changes, advertisers and advertising agents require new advertisement media which can overcome the conventional advertisement media's weakness and are suitable for social and technical environment change.

As a new advertisement medium, an advertisement shown at a theater can use time sufficiently enough to deliver the content of the advertisement and have an intensive impact on the audience by taking advantage of large screen and sound effects.

In the case of movies shown at theaters, before a movie starts, generally advertisements produced by advertisers are shown; a certain number of previews of other movies are played as the time for presenting the movie comes nearer; lights are turned off (dark change) to indicate the start of the movie; and then the main movie is played. In case where advertisement movies continue to be shown before previews are played, the audience's concentration on the advertisements decreases, which is a disadvantage. In order to avoid this disadvantage, a method of inserting advertisement movies into the middle of the previews, instead of keep playing the advertisement movies, is used to increase audience's concentration on the advertisements.

As another way, the same advertisement can be repeatedly played. This way of advertisement may have the advantage of the audience remembering its content for a long time; but, if the advertisement is repeated too many times, the audience may have too much of it so that they would no longer pay attention to the advertisement and be tired of it.

As above, there are efforts of improving advertising effect by playing advertisements in various ways before the movie starts. However, a recent study suggests that when a total of 30 advertisements are played before the audience before the main movie starts, they remember only two or three advertisements, which shows that a variety of effort is required to hold the audience's attention. Particularly, it has been found that the recognition of brands is relatively high when they are shown just before the movie starts.

Further, it has also been found that the recognition of a brand is also affected by creative elements of advertisements as well as the order of the advertisements. For advertisements produced for playing at theaters only, positive attitudes are shown because they could avoid wearing out the audience's patience, which could happen when the same advertisements are shown as on TV, and increase their concentration on individual advertisements, etc. As for the effects of such advertisements on the audience, some audience positively takes advertisements shown at theaters, as compared with those playing in other media, because of ‘opportunity to view new advertisements,’ excitement associated with the theater, ‘sound effects’, etc., whereas others unfavorably rate them because they feel that at theaters, they are forced to see them.

In addition, under conventional systems, an agreement can be made between an advertiser and a theater owner setting a time period for playing advertisements or in consideration of a predetermined number of audience, but it has the disadvantage of requiring much time and efforts for managing the relationship between the advertiser and the theater.

### SUMMARY

The present invention can increase advertising effects without decreasing audience's favorable attitude, which could happen when audience is forced to view commercials in theaters as discussed above, and also lower resistance to the advertisement by increasing its relation with the main movie to lower the audience's perception that it is just another advertisement.

Also, until now, there is no recognition that advertisements can be shown at theaters after lights are turned off because of audience' resistance to the advertisements. An embodiment of the present invention provides a method for producing an advertisement movie, along with a method for playing the advertisement movie, producing an advertisement with a high relevancy with the main movie, such that the audience's resistance to the advertisement can be lowered even though the advertisement movie is played just before the main movie is played.

In another embodiment, the present invention provides a system for providing a movie file embedded with advertisement, wherein advertisement data is inserted into movie data so that the advertisement data is played prior to the movie data, which allows the audience to see the advertisement before the movie and thereby increases advertising effects.

Also, in an embodiment, the present invention provides a method for producing an advertisement and a system using the same, wherein the content of the main movie is related with a brand that is the target of the advertisement, so that the audience can feel like they are watching a movie when the advertisement is played, which can increase advertising effect.

Also, the present invention provides a method for playing an advertisement such that the advertisement produced by a method for producing an advertisement which is related to the movie as above is played just before the movie starts.

The present invention is not limited to the above-mentioned subjects, and other subject(s) which are not mentioned above can be clearly understood by a person skilled in the art from the following descriptions.

A system for providing a movie file embedded with advertisement according to one embodiment of the present invention comprises a file generation part which generates a movie file by inserting advertisement data into movie data; and a data management part which incorporates, when the movie file is generated, the first control data into a header of the movie file, the first control data instructing to play the advertisement data prior to the movie data, wherein the data management part receives data related to a predetermined number of audience, stores the data in the database part, counts the number of audience of the first movie corresponding to the movie file, and displays the remaining number of audience on the header of the movie file after subtracting the counted number of the audience from the predetermined number of audience with reference to the database part.

A system for providing a movie file embedded with advertisement according to one embodiment of the present invention comprises a file generation part which generates a movie file by inserting advertisement data into movie data; and a data management part which incorporates, when the movie file is generated, first control data into a header of the movie file, the first control data instructing to play the advertisement data prior to the movie data, wherein the file generation part is characterized by comprising: a correlation measurement part which measures the correlation between the advertisement data and the movie data for a plurality of advertisements; a filtering part which filters received advertisements based on the measured correlation and selects at least one of the filtered advertisements based on a predetermined bidding condition; and an advertisement insertion part which generates the movie file by inserting advertisement data corresponding to the selected advertisement into the front portion of the movie data.

A system for providing a movie file embedded with advertisement according to another embodiment of the present invention comprises a file generation part which generates a movie file by inserting advertisement data into movie data; and a data management part which incorporates, when the movie file is generated, first control data into a header of the movie file, the first control data instructing to play the advertisement data prior to the movie data, wherein the file generation part is characterized by comprising: a keyword extraction part which extracts a keyword that can be associated with a specific brand which is the target of the advertisement and a keyword that can be associated with the movie data which will be played, respectively; a keyword suitability check part which checks the suitability of each of the keywords for the particular brand and for the movie data extracted from the keyword extraction part, using big data solution; a sentence generation part which generates a sentence from the keywords obtained from the suitability check part; and a movie data generation part which generates the advertisement movie with displaying the sentence generated from the sentence generation part at a predetermined position of the advertisement movie and generates movie data, wherein the advertisement movie is inserted at an opening portion of the movie data.

A method for providing a movie file embedded with advertisement according to one embodiment of the present invention comprises the steps of: generating a movie file by inserting advertisement data into movie data; incorporating, when the movie file is generated, first control data into a header of the movie file, the first control data instructing to play the advertisement data prior to the movie data; receiving data related to a predetermined number of audience and storing the data in a database part; counting the number of audience of the first movie corresponding to the movie file; and displaying the remaining number of audience on the header of the movie file by subtracting the counted number of the audience from the predetermined audience with reference to the database part.

A method for producing an advertisement movie according to one embodiment of the present invention comprises the steps of: extracting a keyword that can be associated with a specific brand which is the target of an advertisement and a keyword that can be associated with movie data which will be played, respectively; checking the suitability of each of the keywords for the specific brand and movie data that are extracted from the step of extracting, using big data solution; generating a sentence from the keywords obtained from the step of checking; and generating the advertisement movie, wherein the sentence generated from the step of generating a sentence is displayed at a predetermined portion of the advertisement movie.

Further, in an embodiment, the above-produced advertisement movie is characterized by being shown just before movie data is played.

Other specific matters of the embodiments are included in the detailed description and accompanying drawings.

According to one embodiment of the present invention, a movie file is generated such that advertisement data is inserted into movie data, and that the advertisement data is played prior to the movie data, and the produced advertisement movie is played at the beginning of the movie data as if it is part of the movie data. Thereby, it is possible to increase audience' concentration on the advertisement.

According to one embodiment of the present invention, only the advertisements which are relevant to the content of the movie are allowed to participate, and thus when the advertisement is played, the audience feels like a movie is played, which can minimize resistance to the advertisement. Thereby, the advertising effect can be maximized.

According to one embodiment of the present invention, an advertisement is produced with keywords obtained by extracting keywords of a brand which is the target of the advertisement and of movie data and checking the suitability of the extracted keywords using big data. General advertisements are not related to movie data and thus they are not able to fix the audience to an advertisement movie. However, according to the present invention, when the advertisement is played, the audience will consider the advertisement part of the movie data, which can increase the audience's concentration on the advertisement.

### BRIEF DESCRIPTION OF THE DRAWINGS

FIG. 1 is a block diagram for illustrating a system for providing a movie file embedded with advertisement according to one embodiment of the present invention.

FIG. 2 is a block diagram illustrating an embodiment of the file generation part of FIG. 1.

FIG. 3 is a block diagram illustrating another embodiment of the file generation part of FIG. 1.

FIG. 4 is a flow chart illustrating a process for producing advertisement by extracting a keyword according to the present invention.

FIG. 5 is a movie poster to which advertisement to be produced according to the present invention may be applied.

FIG. 6 is a drawing illustrating one example of advertisement including a sentence generated according to the process of FIG. 4.

FIG. 7 is a movie poster of another embodiment, to which advertisement to be produced according to the present invention may be applied.

FIGS. 8A and 8B are drawings illustrating examples of advertisement of other embodiments including a sentence generated according to the process of FIG. 4.

FIG. 9 is a block diagram illustrating a system for providing a movie file embedded with advertisement according to another embodiment of the present invention.

FIGS. 10A and 10B are drawings illustrating frame structures of a movie file produced according to one embodiment of the present invention.

FIG. 11 is a flow chart illustrating a method for providing a movie file embedded with advertisement according to one embodiment of the present invention.

FIG. 12 is a flow chart illustrating a process for inserting advertisement data into movie data according to one embodiment of the present invention.

FIGS. 13 and 14 are flow charts illustrating a method for providing a movie file embedded with advertisement according to another embodiment of the present invention.

FIGS. 15 and 16 are flow charts illustrating a method for providing a movie file embedded with advertisement according to another embodiment of the present invention.

The advantages and/or characteristics of the present invention, and methods for achieving them can be clarified by referring to embodiments explained in detail below along with the accompanying drawings. However, the present invention is not limited to the disclosed embodiments but is implemented into various forms. The embodiments of the present invention are provided only to complete the disclosure of the present invention and let a person having ordinary knowledge in the art completely know the scope of the present invention. The present invention is defined only by the scope of claims. The same reference numerals through the specification refer to the same elements.

Hereinafter, the embodiments of the present invention are explained in detail by referring to the accompanying drawings.

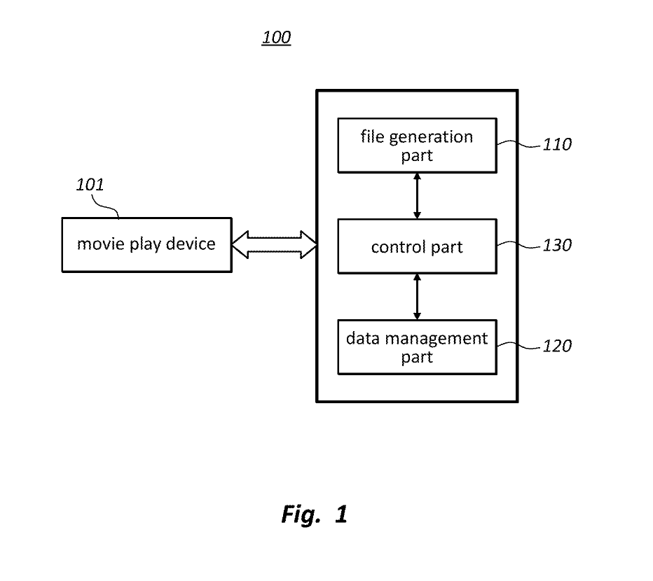

FIG. 1 is a block diagram illustrating a system for providing a movie file embedded with advertisement according to one embodiment of the present invention.

Referring to FIG. 1, a system (100) for providing a movie file embedded with advertisement according to one embodiment of the present invention comprises a file generation part (110) for generating a movie file embedded with advertisement data, a data management part (120) for managing control data, etc. for controlling advertisement data when a movie file is generated, and a control part (130) for generally controlling the operations of the file generation part (110), the data management part (120), etc.

The file generation part (110) generates a movie file by inserting advertisement data into a movie data.

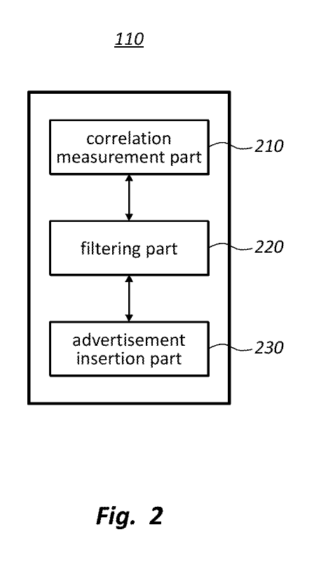

To this end, the file generation part (110) may comprise a correlation measurement part (210), a filtering part (220) and an advertisement insertion part (230), as illustrated in FIG. 2. FIG. 2 is a block diagram illustrating a specific configuration of the file generation part (110) of FIG. 1.

The correlation measurement part (210) may measure a correlation between advertisement data corresponding to a received advertisement and movie data. That is, the correlation measurement part (210) extracts a representative characteristic vector of an object from the advertisement data corresponding to a received advertisement, using Vector Quantization (VQ) algorithm.

For example, the correlation measurement part (210) extracts one or more still image of the advertisement data. The correlation measurement part (210) operates VQ algorithm and extracts from the extracted still image specific values of 8-dimensional vector, that is, 3 color specific values (chromaticity, chroma, brightness) and 5 texture specific values (angular second moment, contrast, correlation, variance, entropy) per one pixel. The correlation measurement part (210) extracts a representative characteristic vector of an object using the extracted 8-dimensional vector's specific values.

The correlation measurement part (210) compares the extracted representative characteristic vector with a representative characteristic vector extracted from the movie data, and measures the correlation between the advertisement data and the movie data.

That is, the correlation measurement part (210) compares the color specific values and texture specific values between the still image of the advertisement data and the still image of the movie data, and calculates a proportion of having the same specific values, to measure the correlation between the advertisement data and the movie data. Here, the correlation may have a value, for example, between 0 and 1, according to the calculated proportion.

The filtering part (220) filters multiple advertisements based on the measured correlation. The filtering part (220) may select at least one of the multiple advertisements through the filtering based on a predetermined condition. Here, the predetermined condition may include information on the advertisement data, for example, price per one play, price per purchase of a movie file (including all of the purchases of recording media, such as CD, DVD, etc. or by distribution on line, etc.), etc.

The advertisement insertion part (230) generates a movie file by inserting the advertisement data corresponding to the selected advertisement into the front portion of the movie data.

In the above, advertisement data corresponding to an advertisement which is selected based on the measurement of the correlation between the previously produced advertisement data and the movie data is inserted into the front portion of the movie data. However, as another embodiment of the file generation part (110), advertisement data where the correlation between the content of the movie data and the brand to be advertised is increased may be produced and inserted into the front portion of the movie data. Hereinafter, we will describe a system and a method for producing advertisement data where the correlation with a brand is increased.

What is intended to be used in the present invention is extracting a plurality of keywords from the image felt from a brand and movie data, respectively and producing advertisement that can correlate with the image of the movie, using big data. Here, the big data that is used does not simply mean that the amount of data is large, but includes the format of data, input and output speed, etc. The big data is a generic term of data in huge scale such that the data cannot be collected, stored, searched, analyzed, etc. by conventional methods because of data explosion, that is, the amounts and types thereof are enormously large compared with conventional data.

For the last ten years, the development of the Internet and computing, the evolution of mobile devices and sensors, the emergence of social network, such as Facebook, Twitter, etc. lead to explosion of the amount of data in companies as well as individuals. The data, texts and documents, communication records, lists of e-commerce in large scale, etc., which are produced therefrom, correspond to big data. For example, big data includes various data, such as weblogs, data obtained by RFID, sensor network, social network, Internet texts/documents, Internet search indexing, detailed records of voice communication, academic study records, such as astronomy/atmospheric science/genetics/biochemistry/biology, etc., military boundary records, medical records, picture lists, video lists, e-commerce acts, etc.

The analysis on the above big data requires quick decision making relatively less, but higher processing complexity, compared with conventional data processing. Also, the amounts of data to be processed are enormous and the proportion of unstructured data is high. In addition, this analysis is high in flexibility of processing and analysis but the amount of data processed at the same time is small, and thus it is not suitable for data analysis which requires ensuring real-time processing. In consideration of the above, Text Mining analysis relates to a technique of searching a value and meaning of unstructured text data based on natural language processing technique. Opinion Mining analysis relates to a technique of collecting and analyzing consumers' opinion from all the web documents, comments, etc. which are scattered over the Internet, such as SNS, blogs, Internet cafes, bulletin boards, Knowledge Search, etc., to extract the reputation on a product or service, etc. Also, Social Network Analytics relates to a technique of analyzing and extracting an individual's or group's influence in social network, interests, tendency and behavior pattern. Cluster Analysis relates to a technique of defining similarity between varying data, measuring distances between the data, and adding the data in nearest order, and this analysis technique is divided into a hierarchical technique and a non-hierarchical technique.

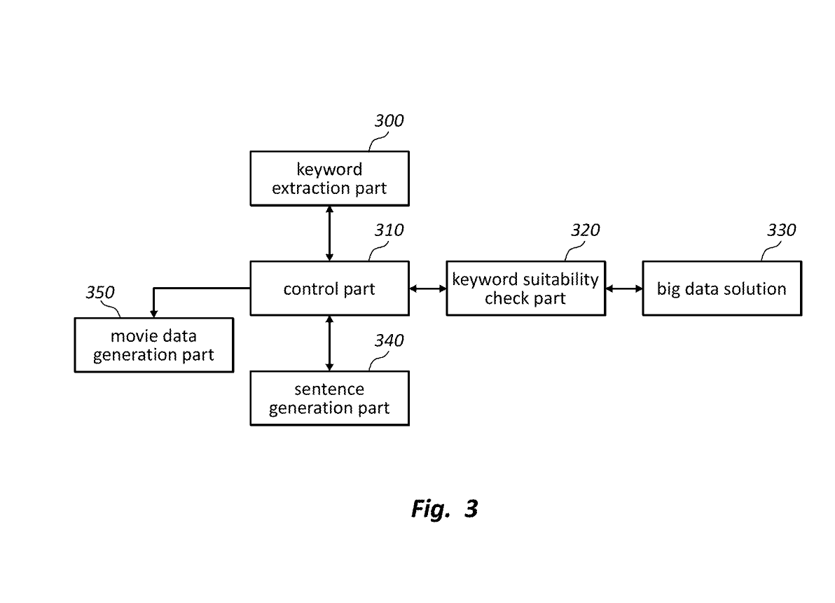

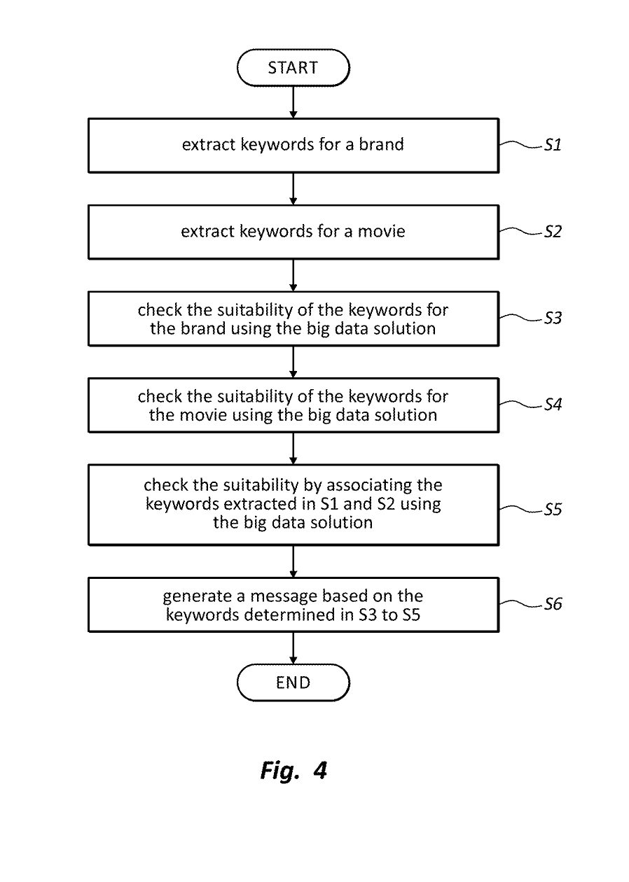

Referring to FIG. 3 showing a block diagram illustrating the configuration of a system for producing advertisement according to movie data according to the present invention and FIG. 4 showing a flow chart briefly illustrating a process for producing advertisement by extracting keywords, the present invention explains a method for producing advertisement data by associating movie data (hereinafter, the movie data refer to movies and may include all the image materials of drama for television or in various forms) with a brand (advertiser) to be advertised by using the above big data and analytic techniques using the same.

First, as for the configuration of an advertisement producing system illustrated in FIG. 3, a control part (310) performing the overall control on the producing system receives from outside, information on a brand which is the target of the advertisement and a movie to be played. Although the data inputted from outside is not specifically illustrated, the data may be provided through an input device, such as a keyboard, etc. If the data for producing advertisement is inputted, for example, if the brand which is the target of the advertisement is Samsung's “Galaxy S” and the movie is “Miracle in Cell No. 7,” the control part (310) receives this information and sends it to a keyword extraction part (300).

The keyword extraction part (300) extracts data that may be a keyword for the brand of the advertiser (S1). For Samsung's “Galaxy S” mentioned as an example above, various keywords, such as “Smart”, “Innovation”, “Technology”, “Samsung”, “Cellular phone”, “Internet LTE”, “Speedy”, “Touch”, “Sensitivity”, “Pattern”, “Camera”, etc. may be extracted as generally recognized keywords. Here, as an example of a method for extracting keywords, keywords may be searched by linking with portal sites. If the keyword “Galaxy S” is searched through portal sites, the search results may be obtained mainly based on keywords which were searched along with “Galaxy S.” Having reviewed the search results, “related search words (related keywords),” which are frequently searched in relation to the keyword, may be obtained. Also, if the related keywords are searched, ‘detail keyword,’ which is another related keyword that is a subconcept related to the related keyword, may be extracted.

With regard to the keyword searched as above, desired keywords (which are searched a lot) for the corresponding brand (“Galaxy S”) can be obtained based on the number of hits for each of the results of the related keywords and detail keywords and arranging the keywords in descending order of the number of hits (in order of the number of hits) as an overall result. Among these obtained keywords, the keywords which are high in ranking may be preferentially set as “main keywords” and the keywords which are low in ranking may be set as “sub keywords.” The “main keywords” and “sub keywords” are for the sake of convenience only, and they may be used without being specifically distinguished. Further, the above method for extracting the keywords is a method only through portal sites, and the extraction of keywords may be possible by various tools which have already been sold or distributed.

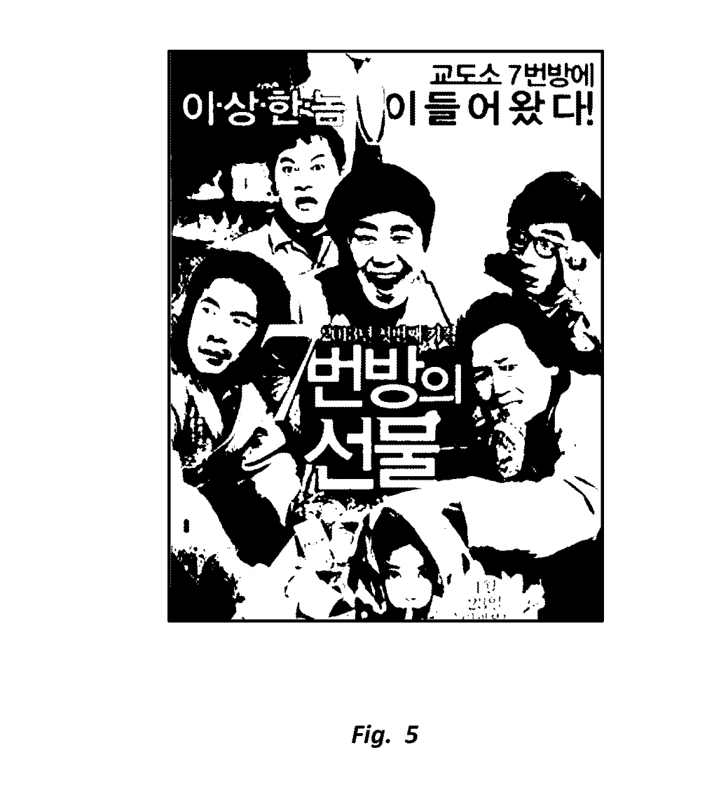

Next, data that may be a keyword for a movie is extracted (S2). The method for extracting a keyword is the same as the method for extracting a keyword of a brand as performed above. The keyword may be extracted by using a different method depending on the case, and the method is not limited to any specific method for extracting a keyword. For example, the method is explained based on the movie “Miracle in Cell No. 7” illustrated in FIG. 5, which recently attracted a large audience. For this movie, various keywords may be extracted as a keyword, such as “family affection”, “daddy”, “daughter”, “acting the fool”, “miracle”, “happiness and sadness”, “being touched”, “friendship”, “prison”, “innocence”, etc.

In the above, the extraction of a keyword for the brand is described as step S1, and the extraction of a keyword for the movie as step S2. However, their sequential order is not fixed, but either S1 or S2 may be performed before the other, or they can be performed at the same time, when the keyword extraction part (300) operates.

If the keyword extraction part (300) finishes the keyword extraction for the brand and movie, the result thereof is provided to keyword suitability check part (320) through the control part (310). Conventionally, extracting a keyword or determining the suitability thereof depend only on human being's reason and intuition. However, the keyword suitability check part (320) of the present invention can extract a keyword more objectively and accurately by going through analytical processes of obtaining suitable keywords using big data solution (search tool) (330). The big data solution (330) can figure out the value of a keyword which is currently exposed by searching conditions by the characteristic of the keyword wherein the keyword is searched by specific conditions for a specific brand, or continuously check the ranking on the Internet, and particularly select a keyword suitable for the situation by analyzing detailed data on each of the keywords and the trend of the keywords.

Also, in order to analyze the value of exposed keywords, the big data solution (330) objectively and systemically analyzes blogs, manages the overall rankings of the blogs by the category, and particularly extracts keywords of power blogs to consider the rankings by the blog and the weighted value on the exposure.

First, the suitability of the plurality of keywords for the brand which is the target of the advertisement, which were prepared in S1, is checked using the big data solution (S3). If the keyword suitability is performed, a result that has correlation in the big data may be obtained, not a keyword for the brand itself. That is, since the big data includes all data which is being used on the Internet including social network, a result on keywords which have correlation with the keywords in S1 using the big data is delivered to the keyword suitability check part (320).

Here, the keyword suitability check part (320) extracts a keyword having the highest correlation from the result of each of the keywords. Among the keywords for “Galaxy S” extracted in S1, the keyword “Smart” was extracted from the analysis result using the big data solution in S3. This result is not always consistent, but a different keyword may be extracted depending on the used solution or conditions of the big data.

Next, for the keywords extracted in S2, that is, for the keywords obtained for the movie, a keyword suitability check was performed by the suitability check part (320) and big data solution (330) in the same manner as performed for the keyword suitability check for the plurality of keywords in S3 (S4). A different solution may be adopted to check the keyword suitability depending on the case, and it is not limited to a specific big data solution. By undergoing this process, for the movie “Miracle in Cell No. 7,” the keyword “fool” was extracted by an analysis of the keywords extracted in S2 using the big data solution in S4. This result is not always consistent, but a different keyword may be extracted depending on a used solution or conditions of the big data, as stated in S3.

In S3, a keyword was extracted through the big data solution using the keywords extracted from the brand which is the target of the advertisement, and in S4, a suitable keyword was extracted from the keywords obtained for the movie. However, data having the highest exposure frequency may be extracted using the big data solution by associating the keywords of the movie and brand with each other. The thus-obtained keyword data may be data which may arouse the most sympathy in relation to the brand or movie on the Internet. By undergoing this process, the keyword “father” is extracted (S5).

If a final keyword is basically determined using the big data solution for the brand which is the target of the advertisement and for the movie, and a final keyword further obtained from the related data is determined, these results are delivered to the control part (310). For the data processing, the control part (310) controls the overall operation in the above embodiments, but the data may be directly delivered to each of the components, not via the control part (310). For example, the result of the keyword suitability check part (320) may be delivered to the sentence generation part (340) via the control part (310) or may be directly delivered to the sentence generation part (340) not via the control part (310).

The keyword is determined in S3 to S5, the result thereof is delivered to the sentence generation part (340), and a message is completed based on the keyword (S6). The keywords “Smart” in S3, “Fool” in S4 and “Father” in S5 were extracted. Various methods may be used as a method for completing a message (sentence) from the keywords. For example, systems for generating a sentence comprise functions such that possible sentences, etc. can be determined in real time using the part of speech of keywords to be inputted. That is, a sentence type in various forms is determined depending on the part of speech of a keyword inputted, and then a type of sentence can be determined where an adverb, adjective, etc. is further added to the determined and set sentence. The additionally completed sentences may be stored in database and the types of sentences which can be possible from the part of speech of the related keywords may be stored in advance and used. In addition to the above method, sentence generation solutions which are provided in various forms may be used.

The sentence generation part (340) generates various sentences by undergoing S6. In S6, a sentence is completed by using keywords obtained in S3 to S5. Basically, a sentence can be completed using only the keywords obtained in S3 and S4. Multiple sentences, not one sentence, can be completed. As examples of the obtained sentences, there are “smart fool”, “the smartest fool”, “the smartest fool in the world”, etc. Further, by undergoing S3 to S5, completed sentences, such as “smart fool, father”, “the smartest fool, father”, “the smartest fool in the world, father”, etc. can be obtained.

The above sentences not only reflect the attributes of the brand which is the target of the advertisement and of the movie, but also are generated with keywords which are widely used or searched by users on the Internet in social network, etc. Thus, if an advertisement is produced in the above manner, it can give a good impression to audience and the advertiser can obtain good advertising effect.

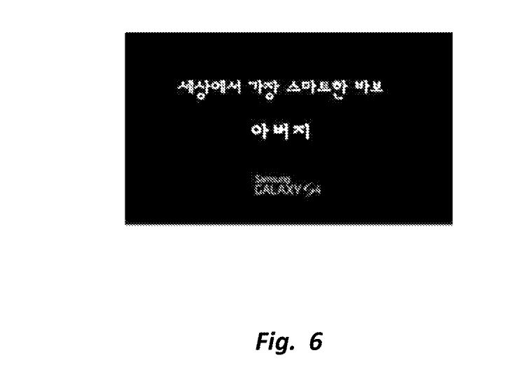

An example of an advertisement applying one example of the completed sentences obtained through S1 to S6 is illustrated in FIG. 6. FIG. 6 illustrates, as an example of the produced advertisement, a still image showing a completed sentence on the brand “Galaxy S” and the movie “Miracle in Cell No. 7.” such still images may be generated by a movie data generation part (350) using the sentences generated in the sentence generation part (340). Basically, the advertisement data produced according to the present invention is based on a sentence completed by using the keywords reflecting the brand and the content of the movie and the keywords with which consumers can sympathize, and thus it is sufficient for the image embedded with the advertisement data to simply let consumers recognize the brand and it can be a still image or a short video clip. However, the present invention is not limited to a specific embodiment and is not specifically limited as long as the characteristics of an advertisement are exhibited.

If the advertisement as illustrated in FIG. 6 is produced according to the present invention, the advertisement is played just before the movie starts, not separately from the movie. That is, the movie data generation part (350) can achieve the most desirable effect by producing the advertisement data to be inserted into the opening portion of the movie data so as to be played as part of the movie. It is general to have a certain time period of dark change after advertisements or previews are played, and then play the movie. If, before the movie “Miracle in Cell No. 7” is played after a dark change, for example, an advertisement of a communication company, which has no correlation with the movie, is played even for a short time, the advertisement may be criticized by the audience, and from the perspective of the advertiser, it could leave bad impression, not good impression, with the audience with regard to the corresponding brand.

However, advertisement data produced according to the present invention combines a keyword of an advertisement with keywords which the audience can feel the most familiar with from the keywords extracted from the movie, i.e., the keywords (fool, father) which are searched by and exposed to the audience the most while on the Internet, and which are closely related to, not separate from, the content of the movie, as an example illustrated in FIG. 6, which allows the audience to deem the advertisement, a type of message, as part of the movie. Also, since the advertisement comprises keywords which may show an image of the brand which is the target of the advertisement in the advertisement message, a good advertising effect can be sufficiently achieved, and in order to further increase the advertising effect, the brand of the corresponding advertisement can also be placed in the advertisement movie.

Particularly, since the advertisement embedded with the above message is played just after a dark change and before the movie starts, its exposure effect or fixed effect is very significant to the audience.

Further, the operation is explained based on the advertisement producing system illustrated in FIG. 3, but the control part (310) in the advertisement producing system in FIG. 3 controls input and output and controls the delivery of the results of each of the components to other components. These functions may be comprised in the keyword extraction part (300), the keyword suitability check part (330), the sentence generation part (340) and the movie data generation part (350), in which case, the configuration of the control part (310) may be omitted.

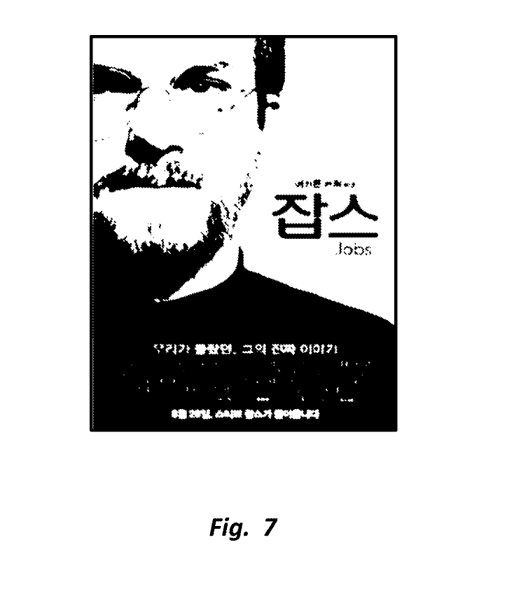

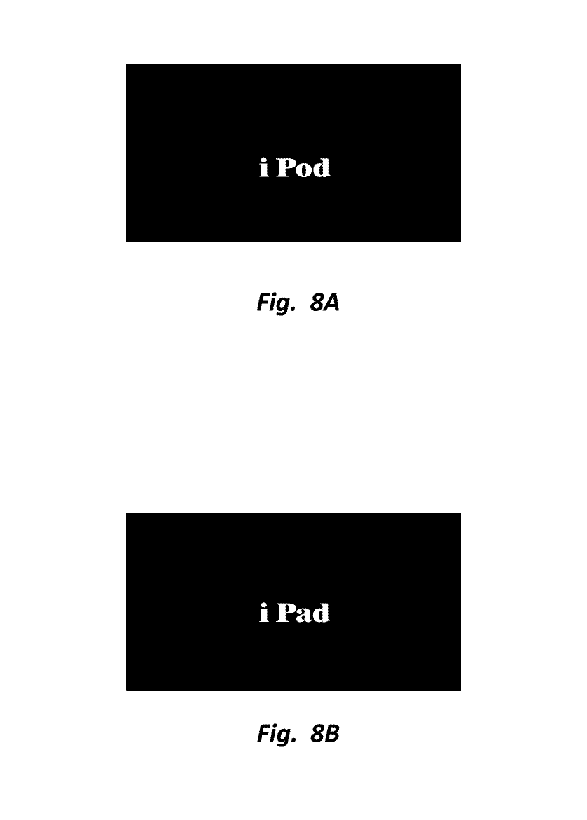

As another embodiment, the movie “Jobs” relating to Steve Jobs and Apple for advertisement are considered as illustrated in FIG. 7. The process for extracting keywords is the same as in S1 and S2 above. The thus-obtained keywords were tested with regard to their suitability using the big data solution to obtain keywords, and for the movie as well, the keywords extracted from the content of the movie were checked with regard to their suitability using the big data solution to obtain keywords (undergoing S3 to S5). As a result, the keywords “iPad”, “iPod”, “iPhone”, etc. were obtained. An advertisement produced using them is illustrated in FIGS. 8A and 8B. Various types of messages (sentences) may be obtained using final keywords which were obtained by extracting from the movie and from the brand which is the target of the advertisement and the final keywords obtained from checking the suitability of the keywords using the big data. The above example is the most well-matched case with the movie, and other various cases can be considered.

Each of the examples illustrated in FIGS. 8A and 8B is a case where one still image is used, and related messages may be displayed on the screen sequentially. Particularly, in case where the suitability of keywords is checked using the big data solution, and keywords closely related to each other, such as “iPod”, “iPad”, “iPhone”, etc., are selected, an advertisement movie may be produced such that the keywords may be displayed on the screen sequentially.

If the advertisement movie is produced as above and this advertisement data is linked with the movie “Jobs” and they are produced as integrated digital data, when the movie is played at theaters, general advertisements are played in general order, previews of other movies are played, and then a dark change follows indicating the start of the main movie. After the dark change, not the movie “Jobs,” but the advertisement of Apple illustrated in FIGS. 8A and 8B is played, and then right after the advertisement comes the main movie. Then, the audience will perceive the advertisement played just before the movie as part of the movie, not an advertisement.

In producing the above advertisement data, sentences were generated with keywords extracted from each of the brand and movie or with final keywords which were obtained from keywords additionally obtained from combining data extracted from each of them using the big data solution, and they were embedded in the advertisement data movie. Here, the background is not limited to a specific color, but simple color, such as black, while, etc. is used as a background. However, the background may be differently produced taking the image of the movie to be played into account.

Meanwhile, the file generation part (110) gets the movie data and the advertisement data produced as above from the database part comprised in the data management part (120) and insert them into the front portion of the movie data, when producing a movie file.

That is, in the database part, advertisements which are similar to the content, characters, background, etc. of the movie are selected to be stored, or advertisement data produced separately is stored. The file generation part (110) produces a movie file by extracting advertisement data which has high correlation with a movie file from the database part and inserting it into the front portion of the movie data.

Referring to FIG. 1 again, when producing a movie file, the data management part (120) incorporates in the header of the movie file the control data (first control data) instructing to play the advertisement data prior to the movie data.

In other words, the data management part (120) may incorporate in the header of the movie file first control data instructing to absolutely play the advertisement data before the movie data is played.

The data management part (120) considers the header to manage the control over the movie data comprised in the body of the movie file and the play of the advertisement data. That is, the data management part (120) considers the header and makes sure that the advertisement data is played prior to the play of the movie data according to the first control data, when the movie file is played by a movie play device (101).

Here, the movie file may be configured to integrate the movie data with the advertisement data. Conventionally, a content provider inserts advertisement data after a movie file configured only with movie data is produced. By comparison, the present embodiment differs in that it inserts advertisement data as part of a movie file when the movie file is initially produced. The present embodiment provides an integrated movie file as above, which shows the advertisement prior to the movie. Thereby, the advertising effect can be increased.

This movie file may be played at theaters, or at home theaters (movie play device for individuals/families) through recording media (CD, DVD, etc.) or files downloaded online. Since the movie file according to the present embodiment is configured such that advertisement data is combined with movie data as one piece, when it is stored on a recording medium or downloaded online, not just the movie data, but also the advertisement data, will be stored or downloaded as one.

When the movie file is played at theaters, advertisements prepared by the theaters separately from the movie file are played before the movie file is played, the advertisement data embedded into the movie file is played when the lights are turned off to start the movie, and then the movie data is played. In this case, the advertising effect of the advertisement data embedded into the movie file can be maximized compared with the advertisements prepared by the theaters. Also, the advertisements prepared by the theaters may be differently played depending on countries or theaters. However, according to the present embodiment, the advertisement data originally inserted into the movie file is steadily played unless a separate editing process is performed. Thus, the advertisement exposure frequency can be maximized.

However, in case the movie file is played at theatres, there is little possibility of the file being edited out because the file is managed by theater managers, etc. However, in case the movie file is provided through a recording medium or a file downloaded online, general users may copy the movie file and make copies of the movie file; during this process, the file could be edited out by such as deleting the advertisement data, etc.

If the movie file is edited out as above, the data management part (120) may detect whether the movie file is edited out by considering the header of the movie file when the movie file is played, and output an error message indicating that the movie file cannot be played. Thus, when the edited movie file is played, the movie play device (101) displays the error message on the screen, but does not play the movie data.

Meanwhile, the data management part (120) may count the number of times the advertisement data has been replayed. The data management part (120) may display a remaining value (remaining number of advertising frequency) on the header of the movie file after subtracting the counted number of replaying times from a predetermined value (a predetermined number of advertising frequency: the total number of possible exposure of the advertisement).

To this end, the data management part (120) may access a data management server (not illustrated) which is linked with the system (100) for providing a movie file, and sends the counted number of replaying times, when the advertisement data is played. The data management server may receive counted numbers of replaying times and add them up. Also, the data management server may calculate a remaining number of advertising frequency after subtracting the added number from the predetermined number of advertising frequency, and the data management part (120) may receive the calculated remaining number of advertising frequency from the data management server and display the remaining number on the header of the movie file.

The data management part (120) may check the remaining number of advertising frequency displayed on the header. As a result, if all of the remaining number is played, the data management part (120) may incorporate into the header control data (second control data) instructing not to play the advertisement data but to directly play the movie data, when the movie file is played.

For example, an advertiser prepays for 1000 times of advertisement. Then, the data management part (120) displays the number ‘1000’ on the header of the movie file as a predetermined number of advertising frequency. The data management part (120) subtracts ‘1’ whenever the advertisement data is played and displays a remaining number on the header. If the remaining number of advertising frequency displayed on the header reaches ‘0’, the data management part (120) incorporates second control data in the header.

Accordingly, the data management part (120) may allow the movie data to be directly played, without the advertisement data being played, according to the second control data incorporated in the header, when the movie file is played by the movie play device (101). This means that the contract for the advertisement data embedded in the movie file has expired, and in order to renew the contract, a new bid may be submitted or a contract extension may be done.

Meanwhile, the data management part (120) may receive data related to the advertisement contract including a predetermined number of audience and advertisement expense, and store the data in the database part. The data management part (120) may count the number of audience watching a movie. Here, the number of audience may include all of the number of audience at theaters, and online sales volumes (number of downloads) and offline sales volumes in connection with the corresponding movie.

The data management part (120) may display a remaining number of audience on the header of the movie file after subtracting the counted number of audience from a predetermined number of audience included in the data on the advertisement contract with reference to the database part.

Here, if the counted number of audience does not reach the predetermined number of audience within a predetermined time period, a process of inserting the advertisement data into a movie file and counting the number of audience may be repeated.

For example, let us assume that the data regarding the advertisement contract includes an advertisement expense of a billon won and sets a predetermined number of audience members to one hundred thousand. In this case, according to one embodiment of the present invention, the corresponding advertisement may be shown before the movie is played until the number of audience of the movie reaches one hundred thousand. However, if the number of audience of the movie does not reach one hundred thousand within a predetermined time period, the corresponding advertisement may be shown before another movie is played. In such a manner, according to one embodiment of the present invention, the corresponding advertisement can be played before one or more movies are played, until the number of audience reaches one hundred thousand.

If the number of audience reaches the predetermined number, the data management part (120) may incorporate the second data in the header. Accordingly, the data management part (120) may allow the movie data to be directly played without the advertisement data being played any longer according to the second control data included in the header, when the movie file is played by the movie play device (101).

The data management part (120) may incorporate into the header control data (fourth control data) limiting at least one of partial skipping function and whole skipping function, when the advertisement data is played.

Accordingly, the data management part (120) may control the advertisement data not to be skipped (partially or wholly) by the fourth control data considering the header, when the movie file is played by the movie play device (101). Thereby, the advertisement data can be played from the beginning till the end, when the movie file is played.

The control part (130) may control the overall operations of the system (100) for providing a movie file embedded with the advertisement according to one embodiment of the present invention, i.e., the file generation part (110), data management part (120), etc.

Meanwhile, the system (100) for providing a movie file embedded with the advertisement according to one embodiment of the present invention may further comprise a data storage part and a billing part, although they are not illustrated in the drawings.

The data storage part may store in the database part (not illustrated) a movie file converted into a file for prohibiting its online distribution, according to the operation of the distribution prohibition algorithm included in the header of the movie file.

If a signal for online distribution of a movie file is inputted, the billing part may charge the advertiser's terminal for an advertisement fee calculated according to the advertisement fee contract. The billing part may allow online distribution of the movie file by recovering the movie file, with the operation of the distribution prohibition algorithm, when the advertisement fee is paid.

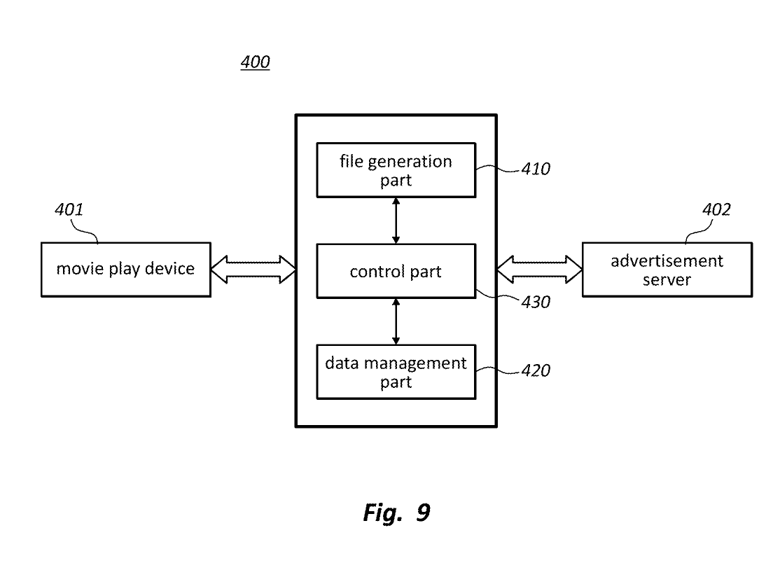

FIG. 9 is a block diagram illustrating a system for providing a movie file embedded with advertisement according to another embodiment of the present invention.

Referring to FIG. 9, the system (400) for providing a movie file embedded with advertisement according to another embodiment of the present invention comprises a file generation part (410), a data management part (420) and a control part (430).

The system (400) for providing a movie file is substantially identical with the system (100) for providing a movie file in FIG. 1, in terms of constitution and performance. Thus, in the present embodiment, the explanation for the same portions as those of the system (100) for providing a movie file in FIG. 1 is omitted, and only the different portions will be explained in detail.

As a result of checking a remaining value displayed on the header, if all the remaining value relating to the play of the advertisement data (first advertisement data) is consumed (remaining value is 0), the system (400) for providing a movie file, unlike the system (100) for providing a movie file in FIG. 1, may produce a movie file by accessing an advertisement server (402) to receive a new advertisement data (second advertisement data) and play it.

To be more specific, 1 is subtracted from a predetermined value, i.e., the total number of replaying times, whenever the first advertisement data is played by the movie play device (401), and in the end, all the remaining value may be consumed. In this case, the data administration part (420) may incorporate URL information for contacting the advertisement server (402), and control data (third control data) in the header of the movie file.

If the movie file is played when all the remaining value is consumed, the data management part (420) may contact the advertisement server (402) using the URL information, without playing the first advertisement data. The data management part (420) receives second advertisement data from the advertisement server (402) by using the third control data, and plays the received second advertisement data in the movie play device (401).

As such, according to another embodiment of the present invention, if all the remaining value on replaying of the advertisement data is consumed, a movie file may be produced such that the second advertisement data is received from the advertisement server (402) and that the new second advertisement data, instead of the first advertisement data, is played. Thus, the advertisement data will always be played prior to the movie, when the movie file is played.

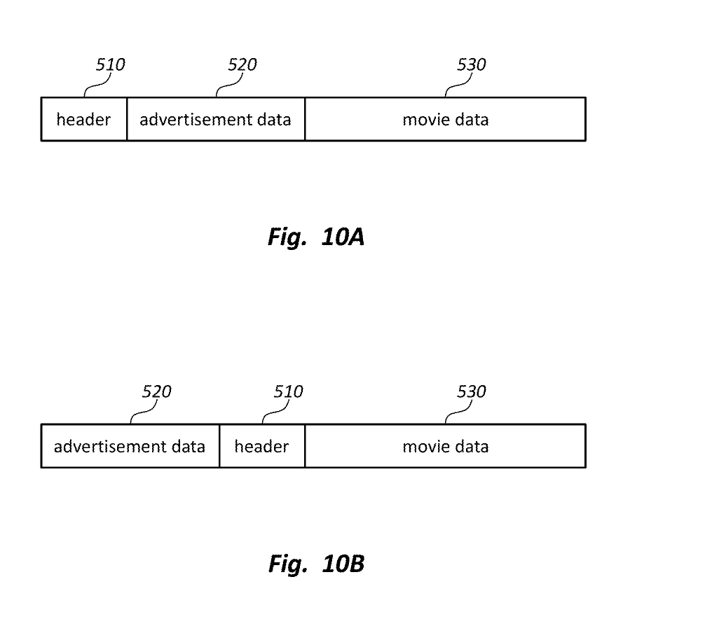

FIGS. 10A and 10B relate to drawings illustrating frame structures of a movie file produced according to one embodiment of the present invention.

As illustrated in FIGS. 10A and 10B, the frame of a movie file may be configured to comprise a header (510), advertisement data (520) and movie data (530). Here, the advertisement data (520) may be inserted before or after the header (510).

That is, as illustrated in FIG. 10A, the frame of a movie file may be configured to insert the advertisement data (520) after the header (510) and position the movie data (530) after the advertisement data (520).

Or, as illustrated in FIG. 10B, the frame of a movie file may be configured to insert the advertisement data (520) before the header (510) and position the movie data (530) after the header (510).

If the frame structure of a movie file is configured as illustrated in FIG. 10B, the advertisement data (520) is performed prior to the header (510), and thus, this embodiment is not subjected to the limitation that the advertisement data (520) must be played through the header (510). In other words, it is not necessary to incorporate into the header (510) control data for always playing the advertisement data (520) before the movie data (530) is played.

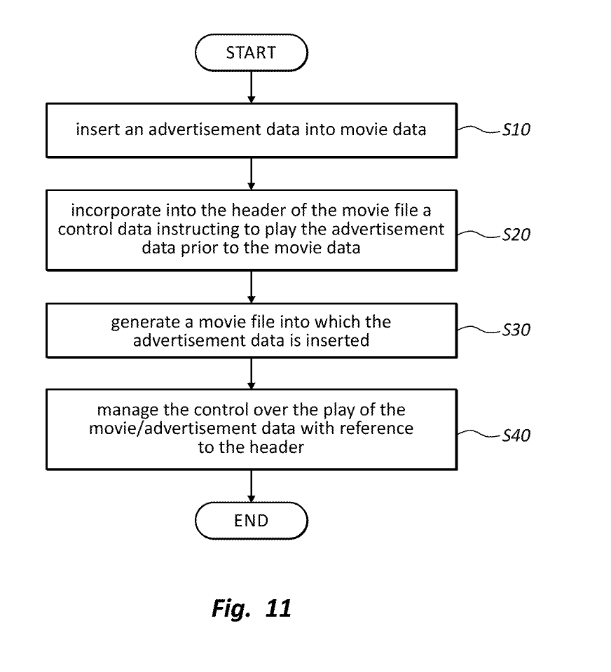

FIG. 11 is a flow chart illustrating a method for providing a movie file embedded with advertisement according to one embodiment of the present invention.

Referring to FIG. 11, in S10, the system for providing a movie file inserts advertisement data into movie data. In S20, the system for providing a movie file incorporates into the header of the movie file control data (first control data) instructing to play the advertisement data prior to the movie data. In S30, the system for providing a movie file generates a movie file into which the advertisement data is to be inserted. In S40, the system for providing a movie file manages the control over the play of the movie data and advertisement data with reference to the header.

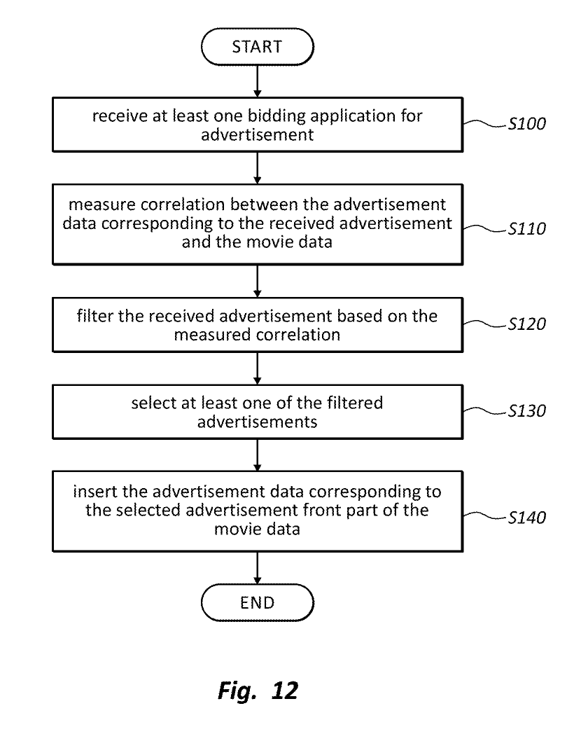

FIG. 12 is a flow chart illustrating a process for inserting advertisement data into movie data according to one embodiment of the present invention.

Referring to FIG. 12, in S100, the system for providing a movie file receives at least one bidding application for advertisement. S100 is a process for collecting advertisements, which is not limited to a bid but may be applied in various forms. In S110, the system for providing a movie file measures correlation between the advertisement data corresponding to the received advertisement and the movie data. In S120, the received advertisement is filtered based on the measured correlation. In S130, at least one of the filtered advertisements is selected based on a predetermined condition. In S140, the system for providing a movie file inserts the advertisement data corresponding to the selected advertisement front part of the movie data.

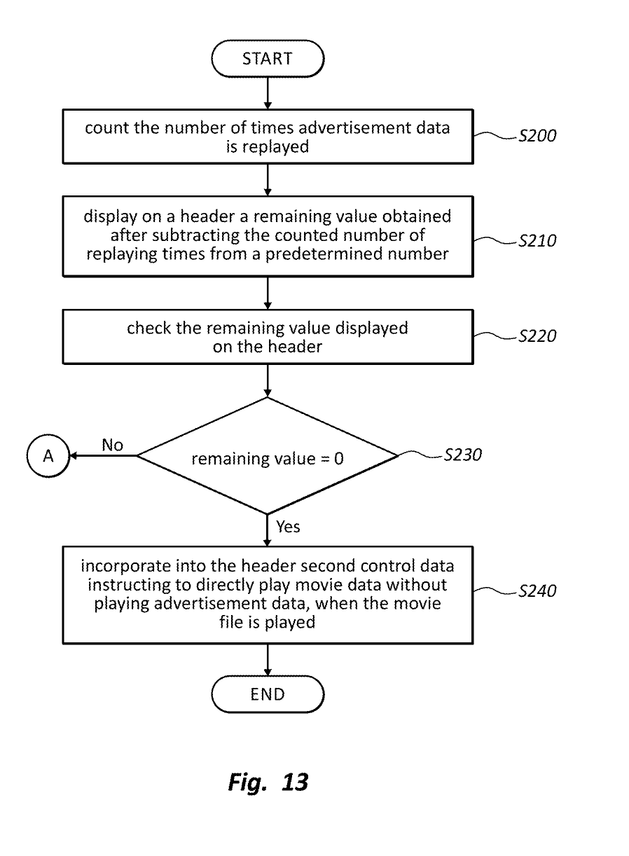

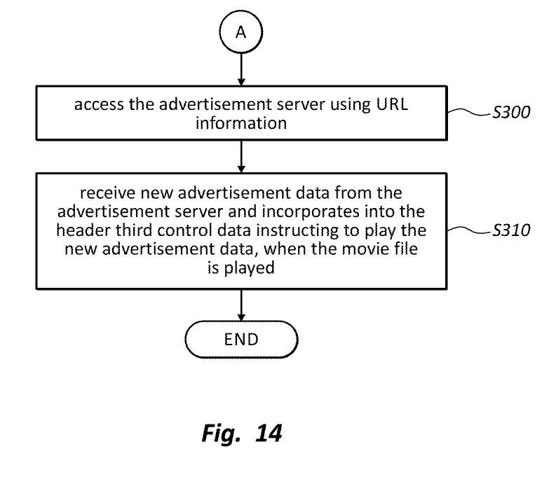

FIGS. 13 and 14 are flow charts illustrating a method for providing a movie file embedded with advertisement according to another embodiment of the present invention.

First, referring to FIG. 13, in S200, the system for providing a movie file counts the number of times advertisement data is replayed. In S210, the system for providing a movie file displays on the header a remaining value obtained after subtracting the counted number of replaying times from a predetermined number. In S220, the system for providing a movie file checks the remaining value displayed on the header.

If the remaining value is 0 as a result of check (to “Yes” in S230), in 3240, the system for providing a movie file incorporates into the header second control data instructing to directly play movie data without playing advertisement data, when the movie file is played.

Or, if the remaining value is not 0 as a result of check (to “No” in S230), the system for providing a movie file goes to the step “A” in FIG. 14.

In other words, referring to FIG. 14, in S300, the system for providing a movie file access the advertisement server using URL information.

Next, in S310, the system for providing a movie file receives new advertisement data different from the advertisement data from the advertisement server and incorporates into the header third control data instructing to play the new advertisement data, instead of the advertisement data, when the movie file is played.

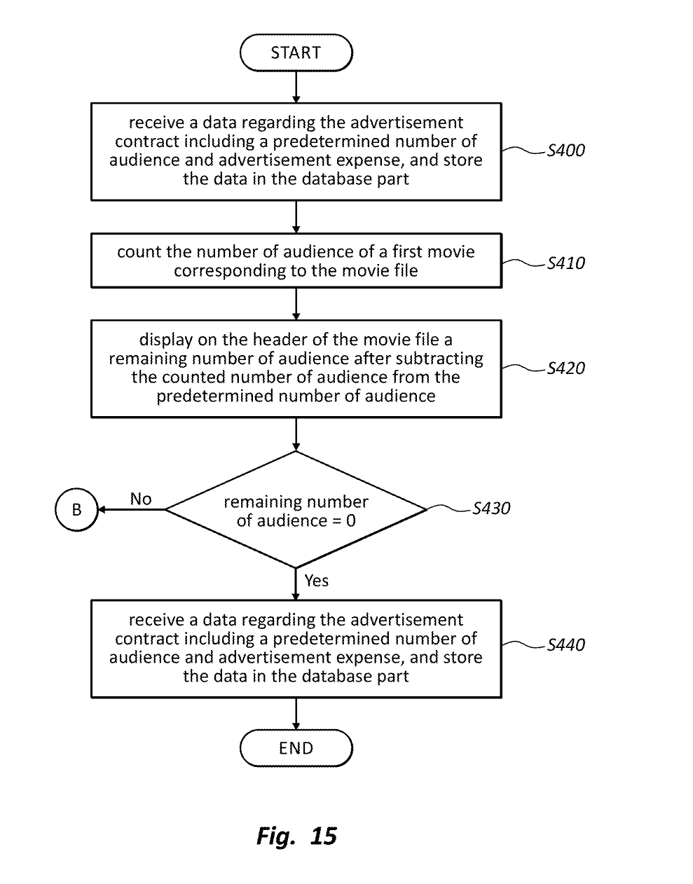

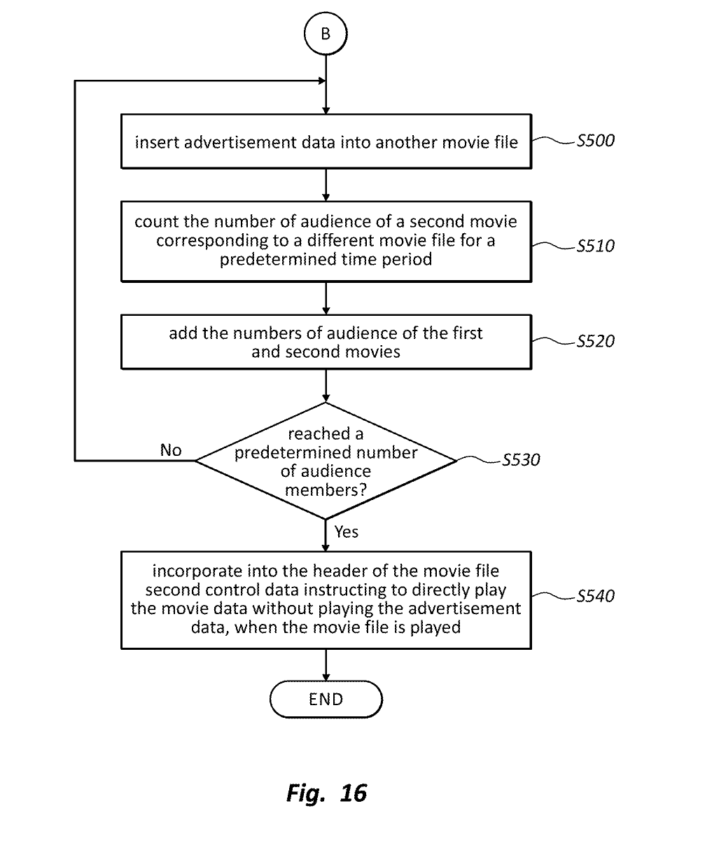

FIGS. 15 and 16 are flow charts illustrating a method for providing a movie file embedded with advertisement according to another embodiment of the present invention.

First, referring to FIG. 15, in S400, the system for providing a movie file receives an input of data regarding the advertisement contract including a predetermined number of audience and advertisement expense, and store the data in the database part. In S410, the system for providing a movie file counts the number of audience of a first movie corresponding to the movie file. In S420, the system for providing a movie file displays on the header of the movie file a remaining number of audience after subtracting the counted number of audience from the predetermined number of audience. In S430, the system for providing a movie file determines whether all the remaining number of audience displayed on the header is consumed (i.e., the remaining number of audience is 0).

If the remaining number of audience is 0 as a result of determination (to “Yes” in S430), in S440, the system for providing a movie file incorporates into the header second control data instructing to directly play movie data without playing advertisement data, when the movie file is played. Or, if the remaining value is not 0 (to “No” in S430), the system for providing a movie file goes to the step “B” in FIG. 16.

Referring to FIG. 16, in S500, the system for providing a movie file inserts advertisement data into another movie file. In S510, the system for providing a movie file counts the number of audience of a second movie corresponding to a different movie file for a predetermined time period. In S520, the system for providing a movie file adds the numbers of audience of the first and second movies. In S530, the system for providing a movie file determines whether the added number of audience reaches a predetermined number of audience members.

If the added number of audience reaches the predetermined number of audience as a result of determination (to “Yes” in S530), in S540, the system for providing a movie file incorporates into the header of the movie file second control data instructing to directly play the movie data without playing the advertisement data, when the movie file is played. Or, if the added number of audience does not reach the predetermined number of audience as a result of determination (to “No” in S530), the system for providing a movie file returns to S500.

As such, one embodiment of the present invention can produce a movie file such that advertisement data is inserted into movie data, and that the advertisement data is played prior to the movie data. Thus, according to one embodiment of the present invention, it is possible to show users advertisement first prior to a movie, which increases advertisement effects. Further, it is possible to create added values (advertising earnings) in other markets and distributions following the success in the movie.

Further, according to one embodiment of the present invention, only advertisements which are relevant to the content of a movie are allowed to participate. Thus, according to one embodiment of the present invention, when an advertisement is played, the audience feels like a movie is played, which can minimize rejection of the advertisement, thereby maximizing the advertising effect.

Further, one embodiment of the present invention can provide a movie file which first plays the advertisement before the movie is played, until a predetermined number of audience according to the advertisement contract is reached. Thus, according to one embodiment of the present invention, it is possible to support a movie (particularly, a low-budget film such as an independent movie) and promote a company (or products of a company) at the same time, which is a win-win situation.

Embodiments of the present invention comprise a computer-readable medium comprising program instructions for executing various operations implemented by computer. The computer-readable medium may comprise a program instruction, a local data file, a local data structure, etc. alone or a combination thereof. The medium is specially designed and configured for the present invention or known to a person skilled in the field of computer software for use. Examples of the computer-readable recording medium include a magnetic medium, such as hard disk, floppy disk, magnetic tape, etc., an optical medium, such as CD-ROM, DVD, etc., a magnetic-optical medium, such as floptical disk, and a hardware device specially configured to store and execute a program instruction, such as ROM, RAM, flash memory, etc. Examples of the program instruction include a machine language code which is made by a complier, and a high-level language code which can be executed by computer using an interpreter, etc.

Specific embodiments according to the present invention are explained. However, various modifications can be made within the scope of the present invention. Therefore, the scope of the present invention shall not be limited to the above-explained embodiments, but by the scope of the claims described below and equivalents to the scope of the claims.

As explained above, the present invention is explained with limited embodiments and drawings. However, the present invention is not limited to the above embodiments, and various modifications and changes can be made based on the descriptions by a person having ordinary knowledge in the art to which the present invention pertains. Therefore, the idea of the present invention should be understood by the claims only, and equivalents and alternatives fall within the idea of the present invention.

1. A system for providing a movie file embedded with advertisement, the system comprising:
a file generation part which generates a movie file by inserting advertisement data into movie data; and
a data management part which incorporates, when the movie file is generated, first control data into a header of the movie file, the first control data instructing to play the advertisement data prior to the movie data,
wherein the data management part receives data related to a predetermined number of audience, stores the data in the database part, counts the number of audience of a first movie corresponding to the movie file, and displays the remaining number of audience on the header of the movie file after subtracting the counted number of the audience from the predetermined number of audience with reference to the database part.

2. The system according to claim 1, wherein the data management part counts the number of times the advertisement data has been replayed and displays the remaining number of advertising frequency on the header after subtracting the counted number of replaying times from a predetermined number of advertising frequency.

3. The system according to claim 2, wherein the data management part checks the remaining number of advertising frequency displayed on the header, and if all of the remaining number is played, incorporates into the header second control data instructing not to play the advertisement data but to directly play the movie data, when the movie file is played.

4. The system according to claim 2, wherein if all of the remaining number of advertising frequency is played, the data management part incorporates into the header URL information for accessing an advertisement server, and third control data receiving new advertisement data different from the advertisement data from the advertisement server using the URL information and instructing to play the new advertisement data instead of the advertisement data, when the movie file is played.

5. The system according to claim 1, wherein the data management part checks the remaining number of audience displayed on the header, and if it is determined as a result of the check that all of the remaining number is reached within a predetermined time period, incorporates into the header second control data instructing not to play the advertisement data but to directly play the movie data, when the movie file is played.

6. The system according to claim 5, wherein if all of the remaining number of audience is not reached within a predetermined time period, the data management part counts the number of audience of a second movie corresponding to a movie file different from the movie file, adds it to the number of audience of the first movie, and if the added number of audience reaches the predetermined number of audience, incorporates the second control data into the header.

7. The system according to claim 1, wherein the data management part incorporates into the header fourth control data, wherein the fourth control data limits at least one of a partial skipping function and a whole skipping function, when the advertisement data is played.

8. A system for providing a movie file embedded with advertisement, the system comprising:
a file generation part which generates a movie file by inserting advertisement data into movie data; and
a data management part which incorporates, when the movie file is generated, first control data into a header of the movie file, the first control data instructing to play the advertisement data prior to the movie data,
wherein the file generation part comprises:
a correlation measurement part which measures the correlation between the advertisement data and the movie data for a plurality of advertisements;
a filtering part which filters received advertisements based on the measured correlation and selects at least one of the filtered advertisements based on a predetermined bidding condition; and
an advertisement insertion part which generates the movie file by inserting advertisement data corresponding to the selected advertisement into the front portion of the movie data.

9. The system according to claim 8, wherein the correlation measurement part extracts a representative characteristic vector of an object from the advertisement data using Vector Quantization (VQ) algorithm, compares the extracted representative characteristic vector with a representative characteristic vector extracted from the movie data, and measures the correlation.

10. The system according to claim 8, wherein the frame structure of the movie file is configured such that the advertisement data is inserted before or after the header, and that the movie data is positioned after the advertisement data.

11. A system for providing a movie file embedded with advertisement, the system comprising:
a file generation part which generates a movie file by inserting advertisement data into movie data; and
a data management part which incorporates, when the movie file is generated, first control data into a header of the movie file, the first control data instructing to play the advertisement data prior to the movie data,
wherein the file generation part comprises:
a keyword extraction part which extracts a keyword that can be associated with a specific brand which is the target of the advertisement and a keyword that can be associated with the movie data which will be played, respectively;
a keyword suitability check part which checks the suitability of each of the keywords for the particular brand and for the movie data extracted from the keyword extraction part, using big data solution;
a sentence generation part which generates a sentence from the keywords obtained from the suitability check part; and
a movie data generation part which generates the advertisement movie with displaying the sentence generated from the sentence generation part at a predetermined position of the advertisement movie and generates movie data, wherein the advertisement movie is inserted at an opening portion of the movie data.

12. The system according to claim 11, wherein the keyword suitability check part further checks the suitability of a plurality of keywords obtained by associating each of the keywords for the particular brand and for the movie data extracted from the keyword extraction part, using big data solution.

13. The system according to claim 12, wherein the sentence generation part generates a plurality of sentences from the keywords obtained from the keyword suitability check part.

14. The system according to claim 13, wherein the movie data generation part generates an advertisement movie where sentences selected from the plurality of sentences generated from the sentence generation part are displayed according to a certain order.

15. The system according to claim 14, wherein the keyword suitability check part extracts keywords from the check results on the keywords checked by means of the big data solution, according to the degree of correlation.

16. A method for providing a movie file embedded with advertisement, the method comprising:
generating a movie file by inserting advertisement data into movie data;
incorporating, when the movie file is generated, first control data into a header of the movie file, the first control data instructing to play the advertisement data prior to the movie data;
receiving data related to a predetermined number of audience and storing the data in a database part;
counting the number of audience of a first movie corresponding to the movie file; and
displaying the remaining number of audience on the header of the movie file after subtracting the counted number of the audience from the predetermined audience with reference to the database part.

17. The method according to claim 16, further comprising:
counting the number of times the advertisement data has been replayed, and
displaying the remaining number of advertising frequency on the header after subtracting the counted number of replaying times from a predetermined number of advertising frequency.

18. The method according to claim 17, further comprising:
checking the remaining number of advertising frequency displayed on the header, and
if it is determined as a result of the check that all of the remaining number is played, incorporating into the header second control data instructing not to play the advertisement data but to directly play the movie data, when the movie file is played.

19. The method according to claim 16, further comprising:
checking the remaining number of audience displayed on the header, and
if it is determined as a result of the check that all of the remaining number is reached within a predetermined time period, incorporating into the header second control data instructing not to play the advertisement data but to directly play the movie data, when the movie file is played.

20. The method according to claim 19, further comprising:
if all of the remaining number of audience is not reached within a predetermined time period, counting the number of audience of a second movie corresponding to a movie file different from the movie file so as to add it to the number of audience of the first movie, and
if the added number of audience reaches the predetermined number of audience, incorporating the second control data into the header.

21. A method for producing an advertisement movie, the method comprising:
extracting a keyword that can be associated with a specific brand which is the target of an advertisement and a keyword that can be associated with movie data which will be played, respectively;
checking the suitability of each of the keywords for the specific brand, and the movie data, that are extracted from the step of extracting, using big data solution;
generating a sentence from the keywords obtained from the step of checking; and
generating an advertisement movie, wherein the sentence generated from the step of generating a sentence is displayed at a predetermined portion of the advertisement movie.

22. The method according to claim 21, wherein the step of checking suitability further comprises a step of checking the suitability of a plurality of keywords obtained by associating each of the keywords for the specific brand, and the movie data, that extracted from the keyword extraction part, using big data solution.

23. The method according to claim 22, wherein the step of generating a sentence comprises a step of generating a plurality of sentences from keywords obtained from the step of checking suitability.

24. The method according to claim 23, wherein the step of generating a sentence comprises a step of generating a plurality of sentences from keywords obtained from the step of checking suitability.

25. The method according to claim 24, wherein the step of generating an advertisement movie comprises a step of generating an advertisement movie where sentences selected from the plurality of sentences generated from the step of generating sentence are displayed in a certain order.

26. The method according to claim 25, wherein the step of checking the suitability comprises a step of extracting keywords from the check results on the keywords checked by means of the big data solution, according to the degree of correlation.

27. A method for playing an advertisement movie, wherein the method playing the advertisement movie produced according to claim 21 just prior to the movie data.

28. The method according to claim 27, wherein the movie data is a movie, and that the advertisement movie is played after a dark change.
